(19) United States
(12) Patent Application Publication
(10) Pub. No.: US 2025/0384524 A1
(43) Pub. Date: Dec. 18, 2025

(54) SYSTEM AND METHOD FOR ENHANCING DETAILS OF AN IMAGE ON AN ELECTRONIC DEVICE

(71) Applicant: SAMSUNG ELECTRONICS CO., LTD., Suwon-si (KR)

(72) Inventors: Rahul VARNA, Bangalore (IN); Deepak Kumar TYAGI, Bangalore (IN); Akshit AGARWAL, Bangalore (IN); Ankur Mani TRIPATHI, Bangalore (IN); Gaurav GOSWAMI, Bangalore (IN); Shivam ARORA, Bangalore (IN)

(73) Assignee: SAMSUNG ELECTRONICS CO., LTD., Suwon-si (KR)

(21) Appl. No.: 19/302,717

(22) Filed: Aug. 18, 2025

Related U.S. Application Data
(63) Continuation of application No. PCT/KR2024/005245, filed on Apr. 18, 2024.

(30) Foreign Application Priority Data
Apr. 18, 2023 (IN) 202341028240
Feb. 7, 2024 (IN) 202341028240

(51) Int. Cl. G06T 5/50; G06T 5/60; G06T 5/70; G06T 5/73; G06T 5/80; G06T 7/593; G06T 7/80; H04N 13/00; H04N 13/156

(52) U.S. Cl. CPC G06T 5/50; G06T 5/60; G06T 5/70; G06T 5/73; G06T 5/80; G06T 7/593; G06T 7/85; H04N 13/156; G06T 2207/10012; G06T 2207/10028; G06T 2207/20221; H04N 2013/0081

(57) ABSTRACT

A system and method for enhancing details of an image on an electronic device are provided. The method includes obtaining a plurality of focal images having a plurality of focal points, generating a blended image using the obtained plurality of focal images, classifying each pixel of a plurality of pixels in the blended image into a pre-defined pixel class of a plurality of pre-defined pixel classes, enhancing each pixel of the plurality of pixels in the blended image based on a pre-defined degree of correction corresponding to respective pre-defined pixel classes associated with each pixel, and providing the image including the enhanced plurality of pixels.

CROSS-REFERENCE TO RELATED APPLICATION(S)

This application is a continuation of International Application No. PCT/KR2024/005245, filed on Apr. 18, 2024, in the Korean Intellectual Property Receiving Office, which claims priority to Indian patent application Ser. No. 20/234,1028240, filed on Apr. 18, 2023, and Indian patent application Ser. No. 202341028240, filed on Feb. 7, 2024, the disclosures of which are incorporated by reference herein in their entireties.

### BACKGROUND

### 1. Field

The disclosure relates to image processing, and more particularly relates to a system and method for enhancing details of an image on an electronic device.

### 2. Description of Related Art

With the advancements in technology, the user may now capture high-resolution images using electronic devices (i.e., smartphones, tablets, and the like), such as 200 Mega Pixel (MP), 108 MP, or 50 MP. However, the captured images have blurry edges or uneven sharpness near the border or at some portions of the images due to incapability of camera sensors of the electronic devices to perform an “all regions focus”. This is owing to the camera sensor's smaller size as compared to a Digital Single-Lens Reflex (DSLR). Further, the blurry edges or the uneven sharpness is predominantly seen in images captured indoors with higher depth of field scenes. Uneven sharpness or blurriness in the captured image is easily observed by users while viewing the images in an image gallery which supports 5× to 10× zoom of the captured scenes. Furthermore, the overall image also suffers from noise in homogenous regions where there are no edges.

FIG. 1 illustrates a pictorial representation depicting one or more issues in the images captured by the electronic device, according to a related art technique. As shown, image 102 shows lesser details and small amounts of halos artifacts at the edges of the image, Further, image 104 shows noise, halos artifacts, and over-sharpening of the image. Furthermore, image 106 shows optimal amounts of details and lesser halos artifacts in the image.

In related art, there are multiple solutions for uniformly enhancing the details of the images by using Artificial Intelligence (AI) based techniques and non-AI-based techniques. The related art solutions introduce extra sharpness at the focus region, resulting in over-sharpening and a noisy image. Thus, the overall captured image looks unnatural. For example, the related art solutions may use a multi-frame Bayer raw image technique. In the multi-frame Bayer raw image technique, several high-resolution multi-frame Bayer raw images are captured at the same focal point. Further, these multi-frames are blended into a single high-resolution frame. The blended high-resolution frame is then passed through an AI model to enhance the overall details of the image. However, capturing multiple frames at the same focus points may not generate “all focus image” in scenes with higher depth of field. Since “all focus image” is not obtained, the AI model is used to improve sharpness, in the blurry region. The AI model increases the details of the image uniformly causing over-sharpening at already focused regions and unnatural edges near the blurry region around object boundaries.

In another example, the related art solutions may use single-frame Bayer raw image technique. In the single-frame Bayer raw image technique, a single high-resolution Bayer raw image is captured at a fixed focus point. Further, the details or sharpness of the scene is improved by using the AI model. However, the AI model increases the sharpness uniformly, causing over-sharpening at already focused regions. Also, noise at the non-focus region in the image is also not removed effectively.

The disclosure addresses the above-mentioned aspects or at least provide a useful alternative for enhancing details of the image on the electronic device.

### SUMMARY

In accordance with an aspect of the disclosure, there is provided a method of enhancing details of an image on an electronic device, the method including: obtaining a plurality of focal images having a plurality of focal points; generating a blended image using the obtained plurality of focal images; classifying each pixel of a plurality of pixels in the blended image into a pre-defined pixel class of a plurality of pre-defined pixel classes; enhancing each pixel of the plurality of pixels in the blended image based on a pre-defined degree of correction corresponding to respective pre-defined pixel classes associated with each pixel; and providing the image including the enhanced plurality of pixels.

The plurality of focal images may be obtained from a secondary camera or a primary camera.

The obtaining the plurality of focal images having the plurality of focal points may include: identifying a location of near and far object points associated with one or more objects appearing in a preview of a primary camera or a secondary camera by using a depth map and a stereo camera configuration; and obtaining the plurality of focal images having the plurality of focal points based on the identified location of the near and far object points.

The depth map may be obtained from at least one of a preview of the primary camera or the secondary camera by using an artificial intelligent (AI) model, or a depth camera.

The plurality of focal images may include a near-focused image, a far-focused image, and a de-focused image.

The generating the blended image may include: identifying one or more common regions in each of the plurality of focal images using at least one of a warping process or a registering process; and generating the blended image by fusing each of the plurality of focal images based on the one or more common regions.

The generating the blended image may include generating the blended image by warping one or more images from the plurality of focal images.

The classifying each pixel of the plurality of pixels in the blended image may include: generating an edge map of the blended image; classifying each pixel of the plurality of pixels of the blended image into the pre-defined pixel class based on the edge map and a depth map; and obtaining a semantic map corresponding to the pre-defined pixel class from the edge map.

The enhancing the details further may include: obtaining a denoised image from the blended image; obtaining a global sharpened image based on the denoised image and a de-focused image from the plurality of focal images; obtaining a low-frequency component, a mid-frequency component, and a high-frequency component of the blended image from the denoised image; generating an adaptively denoised and detail-enhanced (ADE) image corresponding to each of the plurality of pre-defined pixel classes and the obtained semantic map, wherein the ADE image may be generated based on the denoised image, the global sharpened image, a pre-defined degree of correction corresponding to each of the plurality of pre-defined pixel classes, a defocused image from the plurality of focal images, and the obtained low-frequency component, mid-frequency component, and high-frequency component of the blended image; and generating a final ADE image by blending the generated ADE image based on the plurality of pre-defined pixel classes.

According to an aspect of the disclosure, there is provided a system for enhancing details of an image on an electronic device, the system including: a memory storing instructions; one or more processors communicably coupled to the memory, wherein the instructions, when executed by the one or more processors, cause the electronic device to: obtain a plurality of focal images having a plurality of focal points; generate a blended image using the obtained plurality of focal images; classify each pixel of a plurality of pixels in the blended image into a pre-defined pixel class of a plurality of pre-defined pixel classes; enhance each pixel of the plurality of pixels in the blended image based on a pre-defined degree of correction corresponding to the respective pre-defined pixel classes associated with each pixel; and provide the image including the enhanced plurality of pixels.

The plurality of focal images may be obtained from a secondary camera or a primary camera.

In obtaining the plurality of focal images having the plurality of focal points, the one or more processors may be configured to: identify a location of near and far object points associated with one or more objects appearing in a preview of at least a primary camera or a secondary camera by using a depth map and a stereo camera configuration; and obtain the plurality of focal images having the plurality of focal points based on the identified location of the near and far object points.

The depth map may be obtained from at least one of a preview of the primary camera or the secondary camera by using an artificial intelligence (AI) model or a depth camera.

The plurality of focal images may include a near-focused image, a far-focused image, and a de-focused image.

In generating the blended image, the one or more processors may be configured to: identify one or more common regions in each of the plurality of focal images using at least one of a warping process or a registering process; and generate the blended image by fusing each of the plurality of focal images based on the one or more common regions.

### BRIEF DESCRIPTION OF THE DRAWINGS

Aspects and/or features of one or more embodiments will become better understood when the following detailed description is read with reference to the accompanying drawings in which like characters represent like parts throughout the drawings, wherein:

FIG. 1 illustrates a pictorial representation depicting one or more issues in images captured by an electronic device, according to a related art technique;

FIG. 2 illustrates a block diagram of a system for enhancing details of an image on an electronic device, according to an embodiment of the present disclosure;

FIG. 3 illustrates a block diagram of a plurality of modules of the system for enhancing details of the image, according to an embodiment of the present disclosure;

FIG. 4 illustrates a block diagram for generating a final Adaptively Denoised and Detail-Enhanced (ADE) image, according to an embodiment of the present disclosure;

FIGS. 5A-5D illustrate block diagrams for obtaining a plurality of focal images having a plurality of focal points, according to an embodiment of the present disclosure;

FIG. 6 illustrates a block diagram for generating the ADE image, according to an embodiment of the present disclosure;

FIG. 7 illustrates a pictorial representation depicting an operation of the system for enhancing details of the image on the electronic device, in accordance with an embodiment of the present disclosure;

FIGS. 8A-8F illustrate pictorial representations depicting use-case scenarios for enhancing details of the image, in accordance with an embodiment of the present disclosure; and

FIG. 9 is a flow diagram illustrating a method for enhancing details of the image, in accordance with an embodiment of the present disclosure.

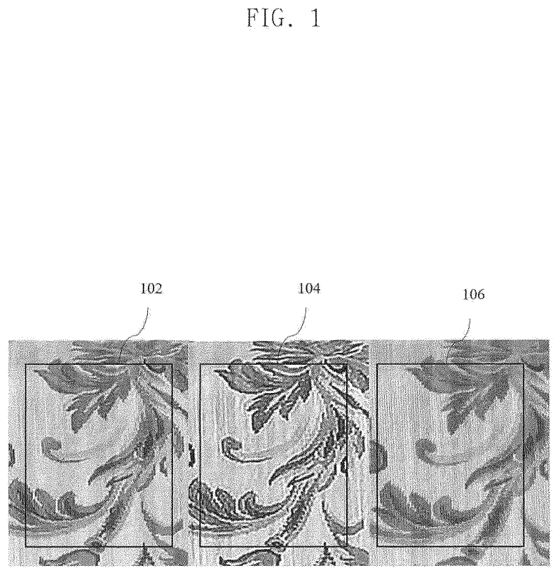

Further, skilled artisans will appreciate that elements in the drawings are illustrated for simplicity and may not have necessarily been drawn to scale. For example, the flow charts illustrate the method in terms of the steps involved to help to improve understanding of aspects of the present disclosure. Furthermore, in terms of the construction of the device, one or more components of the device may have been represented in the drawings by conventional symbols, and the drawings may show only those details that are useful to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to one or more embodiments and language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing description and the following detailed description are explanatory and are not intended to be restrictive thereof.

Reference throughout this disclosure to “an aspect”, “another aspect” or similar language means that a particular feature, structure, or characteristic described in connection with an embodiment is included in at least an embodiment. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

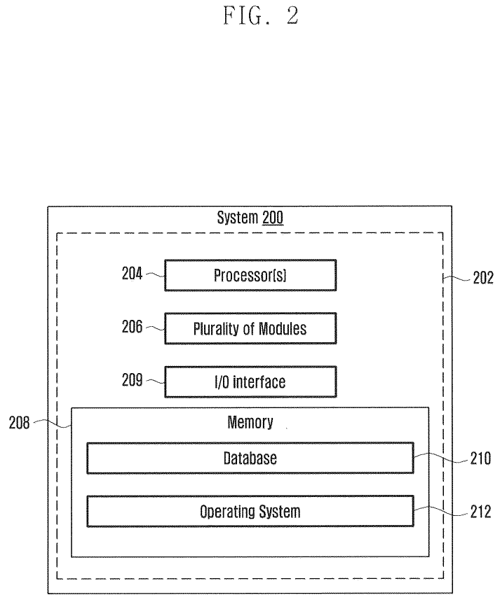

FIG. 2 illustrates a block diagram of a system 200 for enhancing details of an image on an electronic device 202, according to an embodiment of the present disclosure. In an embodiment of the present disclosure, the system 200 may be hosted on the electronic device 202. In an example embodiment of the present disclosure, the electronic device 202 may correspond to a smartphone, a camera, a laptop computer, a wearable device, or any other device capable of capturing an image. The electronic device 202 may include one or more processors 204, a plurality of modules 206, a memory 208, and an Input/Output (I/O) interface 209.

In an example embodiment of the present disclosure, the one or more processors 204 may be operatively coupled to each of the plurality of modules 206, the memory 208, and the I/O interface 209. In an embodiment, the one or more processors 204 may include at least one data processor for executing processes in a Virtual Storage Area Network (VSAN). The one or more processors 204 may include specialized processing units such as integrated system (bus) controllers, memory management control units, floating point units, graphics processing units, digital signal processing units, etc. In an embodiment, the one or more processors 204 may include a central processing unit (CPU), a graphics processing unit (GPU), or both. The one or more processors 204 may be digital signal processors, application-specific integrated circuits, field-programmable gate arrays, servers, networks, digital circuits, analog circuits, combinations thereof, or other now-known or later developed devices for analyzing and processing data. The one or more processors 204 may execute a software program, such as code generated manually (i.e., programmed) to perform the desired operation. In an embodiment of the present disclosure, the one or more processors 204 may be a CPU, an application processor (AP), or the like, a graphics-only processing unit such as the GPU, a visual processing unit (VPU), and/or an Artificial Intelligence (AI)-dedicated processor such as a neural processing unit (NPU). In an embodiment of the present disclosure, the one or more processors 204 execute data, and instructions stored in the memory 208 to enhance details of an image.

The one or more processors 204 may be disposed in communication with one or more input/output (I/O) devices via the respective I/O interface 209. The I/O interface 209 may employ communication code-division multiple access (CDMA), high-speed packet access (HSPA+), global system for mobile communications (GSM), long-term evolution (LTE), WiMax, or the like, etc.

Using the I/O interface 209, the system 200 (or the electronic device 202) may communicate with one or more I/O devices, specifically, the user devices associated with the human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), audio speaker, etc. In an embodiment of the present disclosure, the I/O interface 209 may be used to display the image with enhanced details on a user interface screen of the electronic device 202. The details on enhancing the details of the image have been elaborated in subsequent paragraphs.

The one or more processors 204 may be disposed in communication with a communication network via a network interface. In an embodiment, the network interface may be the I/O interface 209. The network interface may connect to the communication network to enable connection of the system 200 with the outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, and the like.

In some embodiments, the memory 208 may be communicatively coupled to the one or more processors 204. The memory 208 may be configured to store the data, and the instructions executable by the one or more processors 204 for enhancing details of the image. In an embodiment of the present disclosure, the memory 208 may store the data, such as a plurality of focal images, a blended image, a denoised image, a globally sharpened image, and the like. For example, the focal image may be the one which has at least one region of the image in focus. In photography, focus may be the sharpest area of the image. It may be the area where the lens works to highlight an object, a person, or a situation. The blended image may be an image in which two or more images are combined into a single image by doing weighted average of pixels from the two or more images. The denoised image may be the one that has undergone a process to reduce or eliminate noise. In some embodiments, eliminated noise may be gaussian noise, gamma noise, sensor noise, etc. The globally sharpened image may be and image which is not having any blurry region throughout the image. Details on the plurality of focal images, the blended image, the denoised image, the global sharpened image, and the like have been elaborated in subsequent paragraphs. Further, the memory 208 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 208 may include a cache or random-access memory for the one or more processors 204. In alternative examples, the memory 208 is separate from the one or more processors 204, such as a cache memory of a processor, the system memory, or other memory. The memory 208 may be an external storage device or database for storing data. The memory 208 may be operable to store instructions executable by the one or more processors 204. The functions, acts, or tasks illustrated in the figures or described may be performed by the programmed processor/controller for executing the instructions stored in the memory 208. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of modules 206 may be included within the memory 208. The memory 208 may further include a database 210 to store the data for enhancing the details of the image. The plurality of modules 206 may include a set of instructions that may be executed to cause the system 200 to perform any one or more of the methods/processes disclosed herein. The plurality of modules 206 may be configured to perform the steps of the present disclosure using the data stored in the database 210 for enhancing details of the image, as discussed herein. In an embodiment, each of the plurality of modules 206 may be a hardware unit that may be outside the memory 208. Further, the memory 208 may include an operating system 212 for performing one or more tasks of the electronic device 202, as performed by a generic operating system 212 in the communications domain. In an embodiment, the database 210 may be configured to store the information as required by the plurality of modules 206 and the one or more processors 204 to enhance the details of the image.

Further, the present disclosure also contemplates a computer-readable medium that includes instructions or receives and executes instructions responsive to a propagated signal. Further, the instructions may be transmitted or received over the network via a communication port or interface or using a bus. The communication port or interface may be a part of the one or more processors 204 or may be a separate component. The communication port may be created in software or may be a physical connection in hardware. The communication port may be configured to connect with a network, external media, the display, or any other components in the electronic device 202, or combinations thereof. The connection with the network may be a physical connection, such as a wired Ethernet connection, or may be established wirelessly. Likewise, the additional connections with other components of the electronic device 202 may be physical or may be established wirelessly. The network may alternatively be directly connected to the bus. For the sake of brevity, the architecture and standard operations of the operating system 212, the memory 208, the database 210, and the one or more processors 204 are not discussed in detail.

In an embodiment of the present disclosure, the electronic device 202 includes a primary camera, a secondary camera, or a combination thereof. In another embodiment of the present disclosure, the primary camera, the secondary camera, or a combination thereof are separate from the electronic device 202. In such embodiment, the electronic device 202 may receive the plurality of focal images captured by the primary camera, the secondary camera, or a combination via a wireless medium or a wired medium.

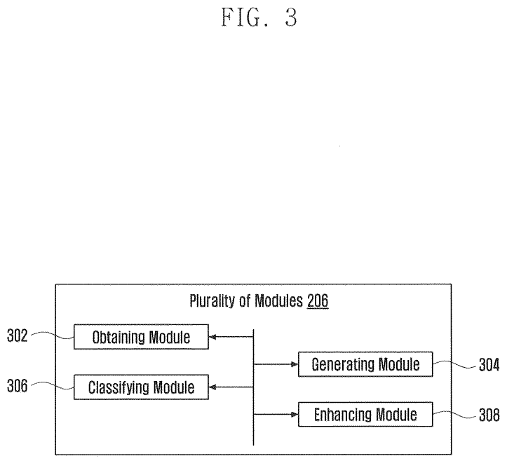

FIG. 3 illustrates a block diagram of a plurality of modules 206 of the system 200 for enhancing details of the image, according to an embodiment of the present disclosure. The illustrated embodiment of FIG. 2 also depicts a sequence flow of process among the plurality of modules 206 for enhancing details of the image. In an embodiment of the present disclosure, the plurality of modules 206 may include, but is not limited to, an obtaining module 302, a generating module 304, a classifying module 306, and an enhancing module 308. The plurality of modules 206 may be implemented by way of suitable hardware and/or software applications.

The obtaining module 302 may be configured to obtain the plurality of focal images having a plurality of focal points. For example, the focal point may be an area (or, point) of the image that catches the eye of the viewer above all else. It may be the point that camera uses to make the photo sharper. If the focal point may be at the center of the image, the camera will focus on that part of the image. This will ensure that captured image has the center in focus. In an embodiment of the present disclosure, the plurality of focal points corresponds to specific areas or elements within the plurality of focal images that are in focus or emphasis and are clearly visible to the user. In an example embodiment of the present disclosure, the plurality of focal images are obtained from the secondary camera, the primary camera, or a combination thereof. In an example embodiment of the present disclosure, the plurality of focal images includes a near-focused image, a far-focused image, and a de-focused image. In an embodiment of the present disclosure, the defocused image corresponds to an image in which nothing is in focus and all the objects in the scene may look blurry. Further, the near focused image corresponds to an image in which the focus is on the nearby object, to the camera, so that these objects are sharper than the objects in the background. Further, the far focused image corresponds to an image in which the focus is on the far objects, to the camera, so that these objects are sharper compared to the foreground.

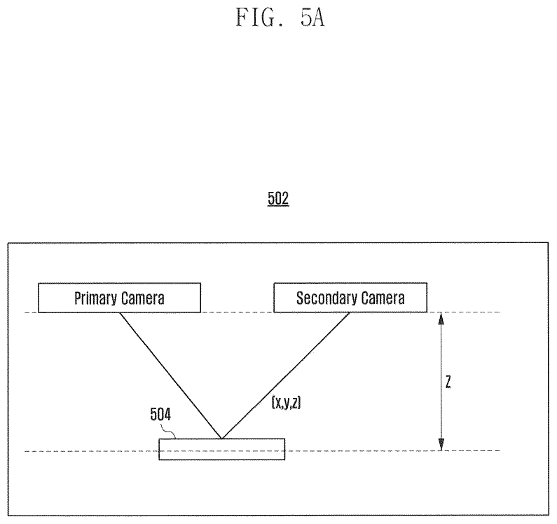

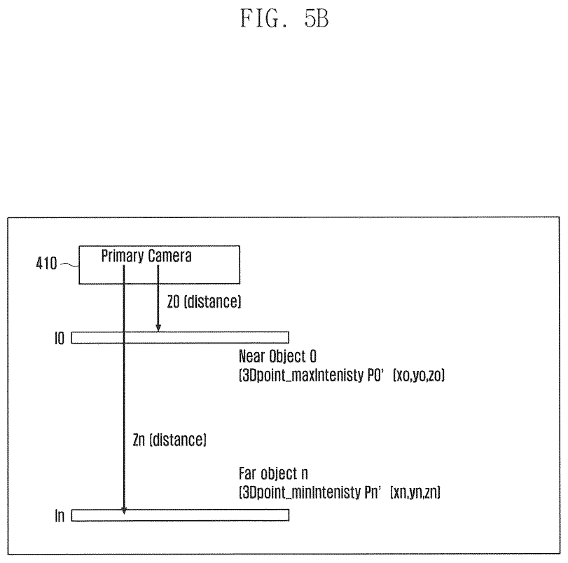

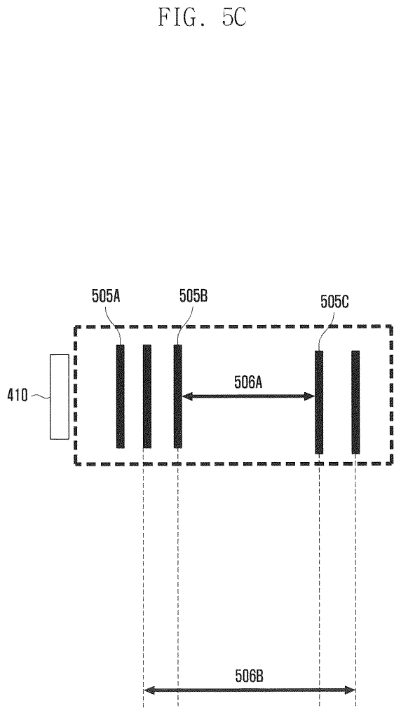

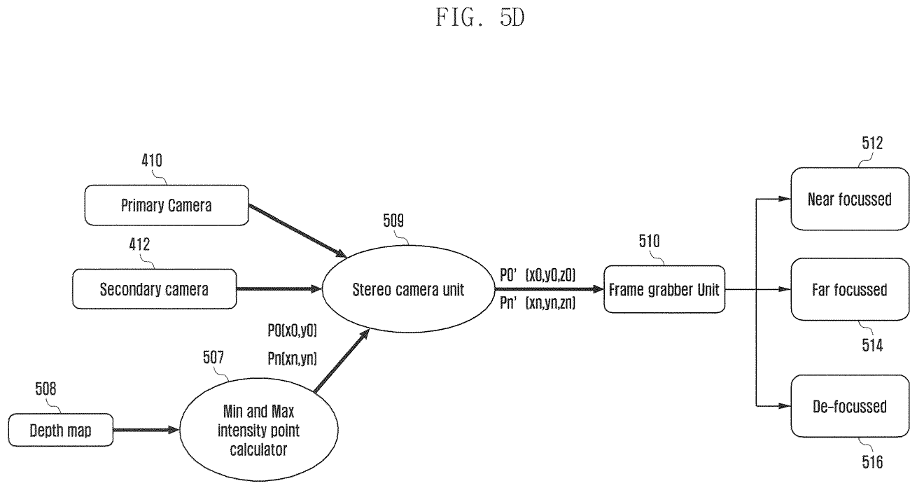

In obtaining the plurality of focal images having the plurality of focal points, the obtaining module 302 may be configured to determine (e.g., identify) a location of near and far object points associated with one or more objects appearing in a preview of the primary camera, the secondary camera, or a combination thereof. In an embodiment of the present disclosure, the near and far object points correspond to the distance of one or more objects within a scene in relation to the camera. The location of the near and far object points is determined by using a depth map and a stereo camera configuration. In an embodiment of the present disclosure, the depth map is a two-dimensional representation of the depth information in a scene associated with the plurality of focal images. The depth map is obtained from a preview of the primary camera, the secondary camera, or a combination thereof by using an Artificial Intelligence (AI) model or from a depth camera. Further, the obtaining module 302 may be configured to obtain the plurality of focal images having the plurality of focal points based on the determined location of the near and far object points. The details on obtaining the plurality of focal images have been elaborated in subsequent paragraphs at least with reference to FIGS. 5A-5D.

Further, the generating module 304 may be configured to generate a blended image using the obtained plurality of focal images. In generating the blended image, the generating module 304 may be configured to identify one or more common regions in each of the plurality of focal images using a warping process, a registering process, or a combination thereof. Furthermore, the generating module 304 may be configured to generate the blended image by fusing each of the plurality of focal images based on the identified one or more common regions.

In generating the blended image, the generating module 304 may be configured to generate the blended image by warping one or more images from the plurality of focal images.

Furthermore, the classifying module 306 may be configured to classify each pixel of a plurality of pixels in the blended image into a pre-defined pixel class of a plurality of pre-defined pixel classes. In classifying each pixel of the plurality of pixels in the blended image, the classifying module 306 may be configured to generate an edge map of the blended image. In an embodiment of the present disclosure, the edge map is a representation of the boundaries or transitions between different regions or objects within the image. Further, the classifying module 306 may be configured to classify each pixel of the plurality of pixels of the blended image into the pre-defined pixel class based on the edge map and the depth map. The classifying module 306 may be configured to obtain a semantic map corresponding to the pre-defined pixel class from the edge map. In an embodiment of the present disclosure, the semantic map corresponds to an image or a representation where different regions or pixels are labeled with semantic information. In an example embodiment of the present disclosure, the semantic information typically denotes the meaning or category of objects, structures, or regions within the scene.

Further, the enhancing module 308 may be configured to enhance each pixel of the plurality of pixels in the blended image based on a pre-defined degree of correction corresponding to the one or more respective pre-defined pixel classes associated with each pixel. The electronic device 202 of system 200 may provide an image including the enhanced plurality of pixels. In enhancing details of the primary camera captured image, the enhancing module 308 may be configured to obtain a denoised image from the blended image. Furthermore, a denoised image is an image that has undergone a process called denoising, which aims to reduce or eliminate noise. The enhancing module 308 may be configured to obtain a global sharpened image based on the denoised image and a de-focused image from the plurality of focal images. In an example embodiment of the present disclosure, the global sharpened image refers to an image that has undergone a sharpening process applied uniformly across the entire image. Further, the de-focused image is an image in which the details are intentionally blurred or not sharply defined or the image is blurry without any sharp objects. The enhancing module 308 may be configured to obtain a low, a mid, and a high-frequency component of the blended image from the denoised image. In an embodiment of the present disclosure, the low-frequency, mid-frequency, and high-frequency components refer to different ranges of spatial frequencies within an image. The spatial frequency refers to the rate at which pixel intensities change across the image.

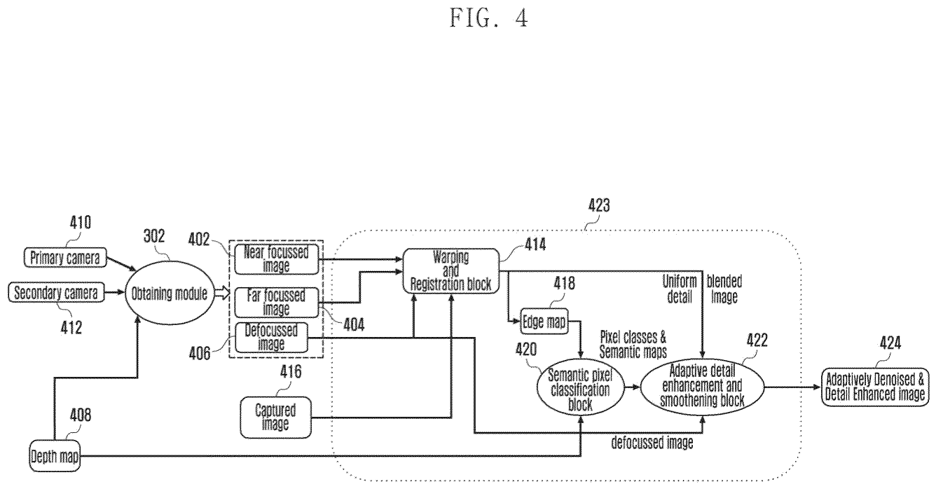

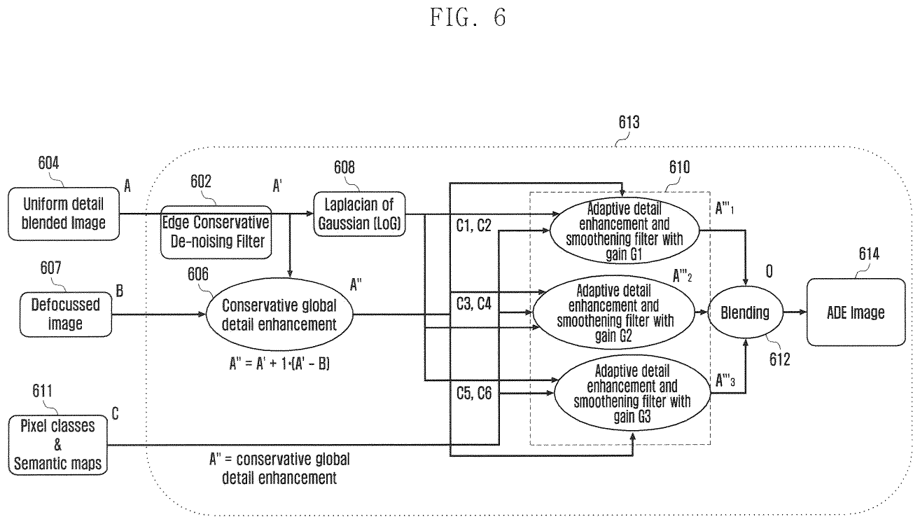

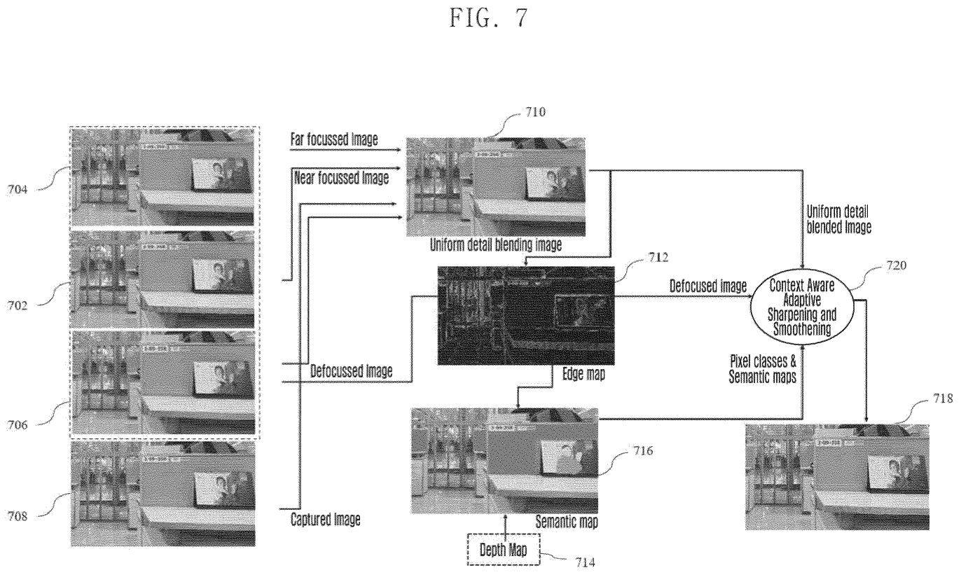

Furthermore, the enhancing module 308 may be configured to generate an Adaptively Denoised and Detail-Enhanced (ADE) image corresponding to each of the plurality of pre-defined pixel classes and the obtained semantic map. In an embodiment of the present disclosure, the ADE image is the final image whose details are enhanced and denoised based on the look up table for obtaining a better enhanced image with finer details and less noise. In an embodiment of the present disclosure, the ADE image is generated based on the denoised image, the global sharpened image, a pre-defined degree of correction corresponding to each of the plurality of pre-defined pixel classes, a defocused image from the plurality of focal images, and the obtained low, mid, and high-frequency components of the blended image. Further, the enhancing module 308 may be configured to generate a final ADE image by blending the generated ADE image based on the plurality of pre-defined pixel classes. The details on generating the final ADE image have been elaborated in subsequent paragraphs at least with reference to FIGS. 4 and 6. Further, details on operation of the system 200 for enhancing details of the image on the electronic device 202 have been elaborated in subsequent paragraphs at least with reference to FIG. 7.

FIG. 4 illustrates a block diagram for generating the final ADE image, according to an embodiment of the present disclosure. Details on the generating of the final ADE image have been elaborated in FIG. 3.

As depicted, the obtaining module 302 obtains the plurality of focal images i.e., the near-focused image 402, the far-focused image 404, and the de-focused image 406, by using the depth map 408, the primary camera 410, the secondary camera 412, or any combination thereof. Further, at warping and registration block 414, the generating module 304 aligns all the frames (i.e., captured image 416, the near-focused image 402, the far-focused image 404, and the de-focused image 406 by cropping and transforming the frames. In an embodiment of the present disclosure, the captured image 416 is captured by the primary camera 410, the secondary camera 412, or any combination thereof. Further, the system 200 identifies the one or more common regions in each of the frames using the warping process, the registering process, or a combination thereof. In an embodiment of the present disclosure, the image registration is a fundamental technique in computer vision and medical imaging that involves aligning two or more images of the same scene or object taken from different perspectives, at different times, or with different or same sensors. The system 200 generates the blended image (uniform detail blended image) by fusing each of the frames based on the one or more common regions. Further, at edge map block 418, the classifying module 306 extracts high-frequency components from the blended image, such as edges to identify the object boundaries. The classifying module 306 generates the edge map based on the identified object boundaries.

Further, at semantic pixel classification block 420, the classifying module 306 classifies each pixel of the plurality of pixels in the blended image into a pre-defined pixel class of the plurality of pre-defined pixel classes. For example, the classifying module 306 classifies the plurality of pixels to the plurality of pre-defined classes by grouping similar pixels with respect to color and object boundary. The color and object boundary are obtained from the edge map to obtain multiple semantic maps.

Furthermore, at adaptive detail enhancement and smoothening block 422, the system 200 adaptively sharpens and smoothens the plurality of pixels based on the pre-defined pixel classes to generate the final ADE image 424. In an embodiment of the present disclosure, steps 414, 418, 420, and 422 are performed by scene aware adaptive detail enhancement with de-noising block 423.

In an embodiment of the present disclosure, each pixel class of the plurality of pre-defined pixel classes requires a different level of enhancement. For example, a pixel class corresponding to the fabrics, animals, and pets fur requires more detail enhancement as compared to the pixel class corresponding to the leaves, grass, flowers, trees, and mountains.

FIGS. 5A-5D illustrate block diagrams for obtaining the plurality of focal images having the plurality of focal points, according to an embodiment of the present disclosure. For the sake of brevity, FIGS. 5A-5D are explained together. Details on obtaining the plurality of focal images having the plurality of focal points have been briefly explained in FIG. 3.

As shown in FIG. 5A, numeral 502 is the stereo camera configuration of the primary camera 410 and the secondary camera 412. Further, ‘Z’ represents the distance between an object 504 and the cameras i.e., the primary camera 410 and the secondary camera 412.

Further, as shown in FIG. 5B, ‘Z0’ represents a distance between the primary camera 410 and a near object ‘I0’ i.e., 3Dpoint_maxIntenisty P0′ (xo, yo, zo). Further, ‘Zn’ represents a distance between the primary camera 410 and a far object ‘In’ i.e., (3Dpoint_minIntenisty Pn′ (xn, yn, zn). The system 200 obtains Z0 and Zn values of maximum and minimum intensity points using the depth map and the obtaining module 302.

As shown in FIG. 5C, a numeral 505A represents the lens position for the defocused frame. A numeral 505B represents the lens position for a near-focused frame. Further, a numeral 505C represents the lens position for the far-focused frame. Furthermore, a numeral 506A represents the range of objects and 506B represents the autofocus range of the primary camera 410.

In an embodiment of the present disclosure, the lens position (Af_dis) is displaced to capture the defocused frame, the far-focused frame, and the near-focused frame by using a look-up table (Table 1). Further, the system 200 uses equation (1) for calculating the lens position:

$$Af\_dis = func ( z value ) \qquad equation ( 1 )$$

TABLE 1

| Z value (mm) | Af_dis (Lens Position) (mm) |
|---|---|
| 0 | 0 |
| 0.1 (Z1) | 0.005 |
| 0.2 (Z2) | 0.006 |

Furthermore, as shown in FIG. 5D, a min and max intensity point calculator 507 determines a maximum and minimum intensity seed pixels of the depth map 508. In an embodiment of the present disclosure, the maximum and minimum intensity seed pixels determination is performed to identify the foreground object and background object to focus on, such that stereo camera can take multiple images at different focus points. Further, the min and max intensity point calculator 507 determines the minimum and maximum intensity points in two dimensions (2D) i.e., P0 (x0, y0) & Pn (xn, yn). Further, a stereo camera unit 509 calculates the distance ‘Z’ between the object 504 and the cameras i.e., the primary camera 410 and the secondary camera 412. Furthermore, a frame grabber unit 510 moves the lens of the primary camera 410, the secondary camera 412, or any combination thereof to capture the near-focused image 512, the far-focused image 514, and the de-focused image 516.

FIG. 6 illustrates a block diagram for generating the ADE image, according to an embodiment of the present disclosure. Details on the generating of the final ADE image have been elaborated in FIG. 3.

As shown in the Figure, an edge conservative de-noising filter 602 of the system 200 removes the noise from the uniform detail blended image 604 (as represented by A) before performing adaptive detail enhancement. The output of the edge conservative de-noising filter 602 is a filtered image with preserved edges (as represented by A′). Further, at conservative global detail enhancement block 606, the system 200 performs global sharpening on the defocussed image 607 (as represented by B) and filtered image with preserved edges (A′) to conservatively add details such that o6ver-sharpening does not occur. The output of the conservative global detail enhancement block 606 of the system 200 is the global sharpened image (as represented by A″). For example, the conservative global detail enhancement block 606 is used for a small amount of detail enhancement and reconstruction of lost details in blurred regions. The global sharpened image is obtained using the equation (2).

$${A}^{″} = {A}^{′} + 1 * ( {A}^{′} - B ) \qquad ( 2 )$$

Further, at Laplacian of Gaussian (LoG) block 608, the system 200 obtains low, mid, and high-frequency components of the filtered image with preserved edges (A′) based on LoG value. The output of the LoG block 608 is an image with LoG values. Further, the inputs of an adaptive detail enhancement and smoothening filter 610 is the global sharpened image, image with LoG values, pixel classes (C1-C6), and their respective semantic maps 611. The output of the adaptive detail enhancement and smoothening filter 610 is pixels classes with adaptive denoised and detail enhancement. The adaptive detail enhancement and smoothening filter 610 adaptively sharpen and smoothen the pixels based on pixel classes, the sharpening gain, and LoG values, such that pixel category-wise detail enhancement is done with minimized artifacts. For example, scene-aware adaptive detail enhancement associated with gain 1 is represented by A″′₁, scene-aware adaptive detail enhancement associated with gain 2 is represented by A″′₂, and scene-aware adaptive detail enhancement associated with gain 3 is represented by A″′₃. In an embodiment of the present disclosure, the adaptive detail enhancement and smoothening filter 610 is used for context adaptive detail enhancement for natural scenes and lesser noises. Table 2 shows a relation between categories of the objects in a scene and variable parameter values. For example, variable parameters, such as G=7, λ=0.05 are the sharpening gain (G) & image mean (λ).

Furthermore, at blending block 612, the system 200 blends different classes of pixels to have smooth boundaries between pixel classes. As a result, a scene-aware detail-enhanced image is generated i.e., the final ADE image 614. In an embodiment of the present disclosure, the steps 602, 606, 608, 610, and 612 are performed by adaptive detail enhancement and smoothening block 613. In an embodiment of the present disclosure, the system 200 uses equation (3) to perform the blending process.

$$O = blending ( {A}_{1}^{′′′} , {A}_{2}^{′′′} , {A}_{3}^{′′′} … {A}_{n}^{′′′} ) \qquad ( 3 )$$

$${A}_{n}^{′′′} = {α}_{n} * {A}_{n}^{″} + {β}_{n}$$

$${α}_{n} = {α}_{n} + function ( {LoG}_{n} , {σ}_{n}^{2} , {λ}_{n} , {G}_{n} )$$

$${β}_{n} = ( 1 - {μ}_{n} ) * {α}_{n}$$

TABLE 2

| | | Variable |
|---|---|---|
| Categories | Classes | Parameter values |
| Fabrics, Animals/pets | C1 | G = 7, λ = 0.05 |
| fur | | |
| Leaves, grass, flowers, | C2 | G = 6, λ = 0.05 |
| trees, mountains | | |
| Buildings, structures, | C3 | G = 4, λ = 0.05 |
| walls, high texture, | | |
| Furniture surface | | |
| Text in different | C4 | G = 4, λ = 0.05 |
| languages, barcodes | | |
| Skin, Faces, eyes, hairs | C5 | G = 3, λ = 0.05 |
| Sky, clouds. glass, flat | C6 | G = 3, λ = 0.05 |
| surfaces | | |

FIG. 7 illustrates a pictorial representation depicting an operation of the system 200 for enhancing details of the image on the electronic device 202, in accordance with an embodiment of the present disclosure. Details on the system 200 for enhancing details of the image on the electronic device 202 have been elaborated in FIGS. 3 and 4.

As depicted, the system 200 obtains the near-focused image 702, the far-focused image 704, the defocussed image 706, the captured image 708 (i.e., high-resolution default capture), and depth map images. Further, the wrapping and registration block 414 of the system 200 generates the uniform detail blended image 710 based on the obtained images (702-708). The generated uniform blended image 710 is passed through the edge map block 418 to generate the edge map image 712 which contains high frequency edge details of the image. Further, the edge map image 712 and the depth map images 714 are used by the semantic pixel classification block 420 to generate segmentation map regions & pixel classes 716 associated with those regions. Furthermore, the uniform detail blended image 710, the defocused image 706, and pixel classes with their respective segmented regions 716 are used by the adaptively denoised and detail-enhanced image block 422 to generate the final enhanced high-resolution capture image 718. The final enhanced high-resolution capture image 718 by performing context-aware adaptive sharpening and smoothening at step 720. In an embodiment of the present disclosure, adaptive detail enhancement & denoising are done by referring to the look-up table (for example, Table 3) associating pixel class with respect to detail enhancement strength.

TABLE 3

| Pixel | | Needed detail |
|---|---|---|
| Classes | Categories | enhancement |
| C1 | Fabrics, | 70% |
| | Animals/ | |
| | pets fur | |
| C2 | Leaves, | 60% |
| | grass, | |
| | flowers, | |
| | trees, | |
| | mountains | |
| C3 | Buildings, | 55% |
| | structures, | |
| | walls, high | |
| | texture, | |
| | Furniture | |
| | surface | |
| C4 | Text in | 50% |
| | different | |
| | languages, | |
| | barcodes | |
| C5 | Sky, | 50% |
| | clouds. | |
| | glass, flat | |
| | surfaces | |
| C6 | Skin, | 40% |
| | Faces, | |
| | eyes, hairs | |

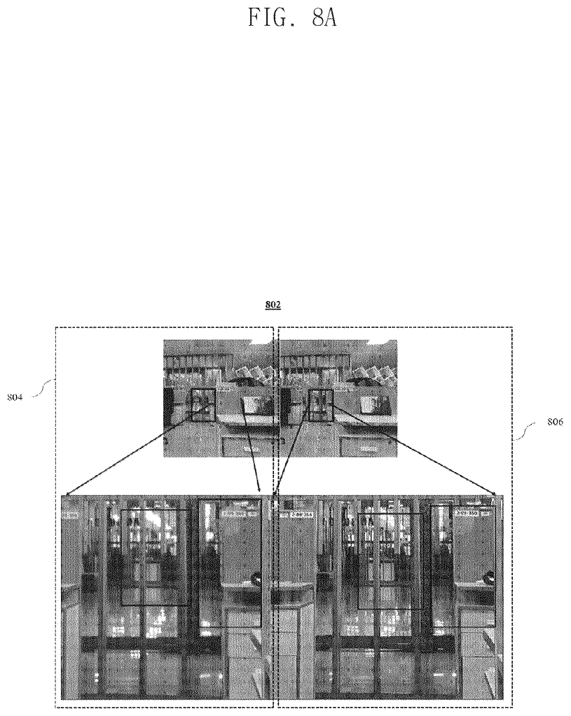

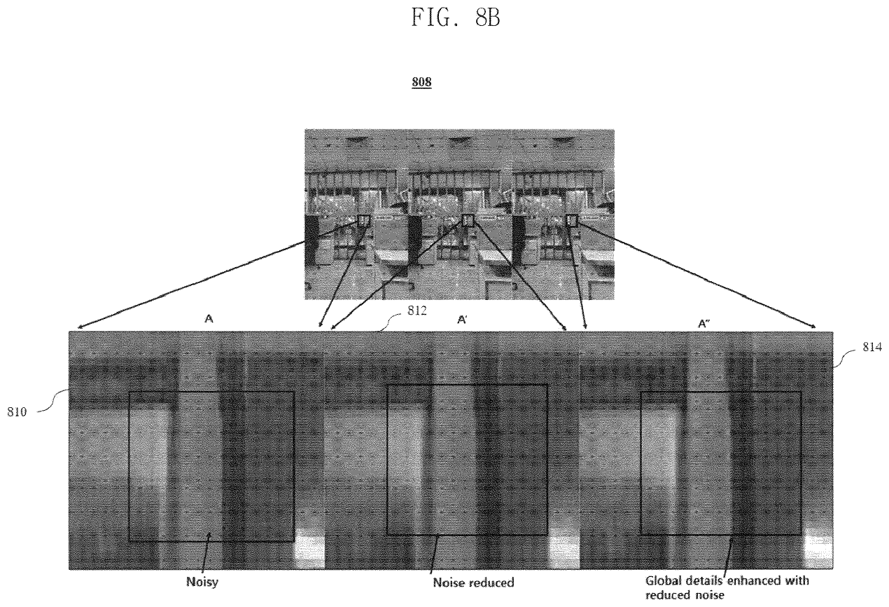

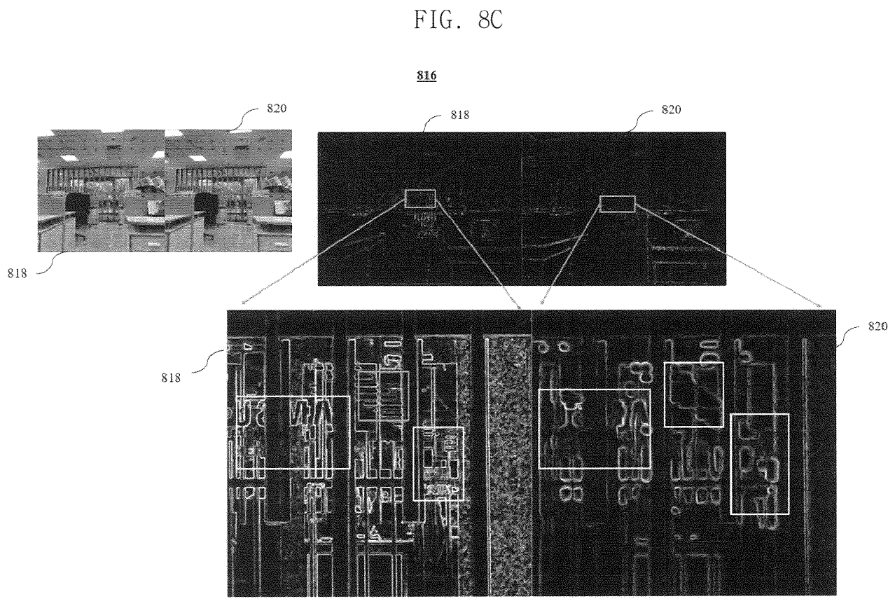

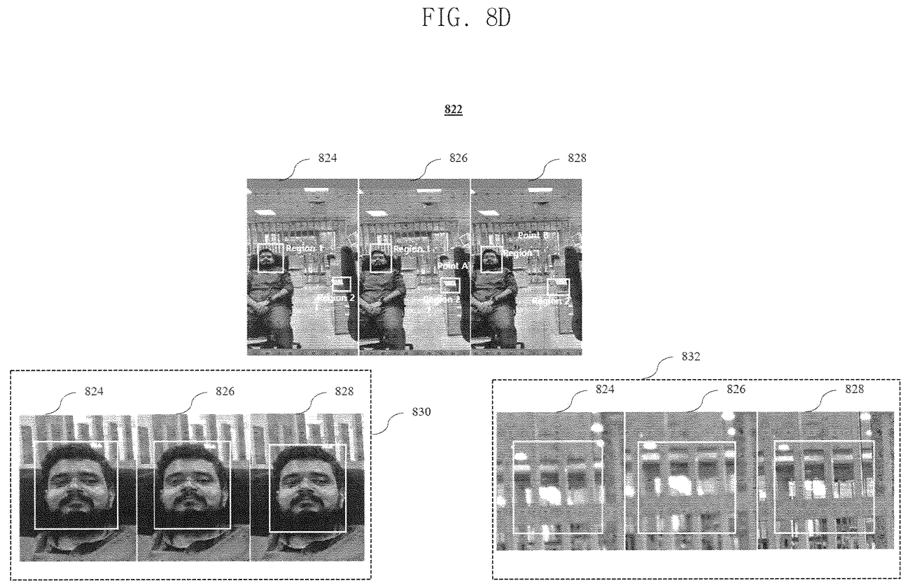

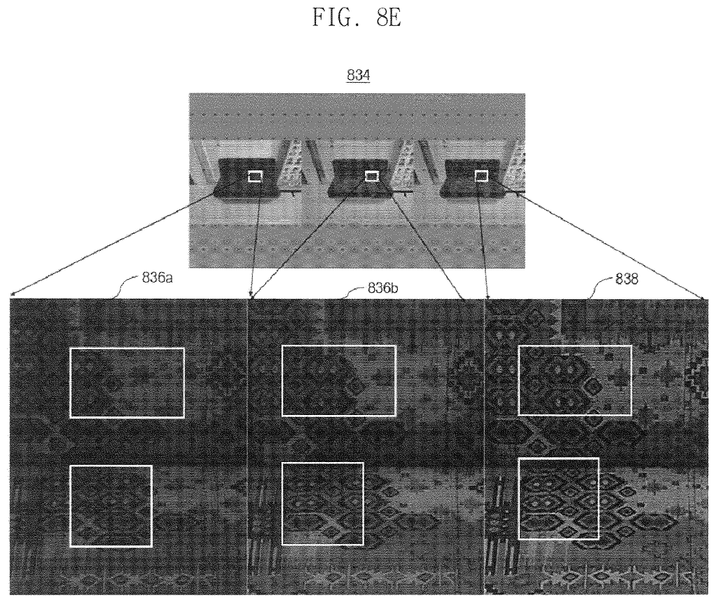

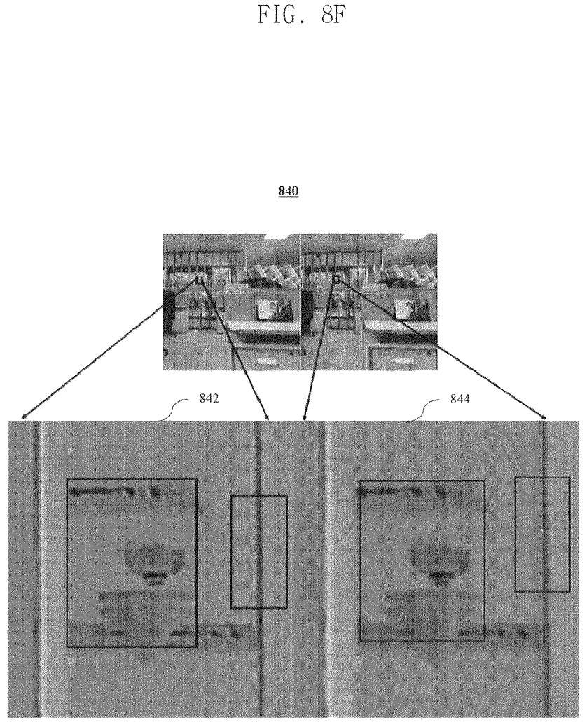

FIGS. 8A-8F illustrate pictorial representations depicting use-case scenarios for enhancing details of the image, in accordance with an embodiment of the present disclosure. For the sake of brevity, FIGS. 8A-8F are explained together. Details on enhancing the details of the image have been elaborated in FIG. 3.

FIG. 8A shows a use case scenario 802 of enhancing the details of an image in which the object categories are buildings and walls. In the image 804 enhanced using the related art technique, blurry regions i.e., as the depth of field of the scene is very high. However, in the image 806 enhanced using the present disclosure, the sharpening of the wall area and wooden structure is performed at varying strengths.

FIG. 8B shows another use case scenario 808 of global conservative sharpening using the defocussed frame. Image 810 represents a blended image with uniform focus and details i.e., the noisy image (A). Further, image 812 represents an edge conservative de-noising filter image i.e., the de-noised image (A′). Further, image 814 represents global conservative sharpening using a defocussed frame i.e., global details enhanced with reduced noise (A″)

Further, in the related art technique, A″ with halos and noises is calculated using equation (4). A″ with lesser halos and noises in the present disclosure is calculated using equation (5).

$${A}^{″} = {A}^{′} + amount * ( {A}^{′} - B\_blurred ) \qquad equation ( 4 )$$

$${A}^{″} = {A}^{′} + amount * ( {A}^{′} - B\_defocussed ) \qquad equation ( 5 )$$

Here, B_defocussed represents the defocussed frame, B_blurred- represents the image blurred with a convolution filter, and an amount represents the sharpening gain.

In an embodiment of the present disclosure, A′ includes high-frequency, mid-frequency, and low-frequency components. B_defocussed includes very low-frequency components. Thus, (A−B_defocussed) step signifies obtaining strong (high+mid frequency), i.e., image with very low frequency components. Further, the amount*(A′−B_defocussed) step signifies strong high and mid frequency, thus a lower “amount” value leads to a sharpened image with no halos at the edges. Further, B_blurred includes mid and low frequencies. Thus, (A−B_blurred) step signifies obtaining high frequency, i.e., an image with mid+low frequencies. Further, the amount*(A′−B_blurred) step signifies only high-frequency components, thus a lower “amount” value leads to the lesser sharpened image and a higher “amount” value leads to an over-sharpened image with the halos edges.

FIG. 8C shows another use case scenario 816 of edge map comparison for the uniform detail blended image 818 and a single frame 820. As shown, the single frame 820 has irregular edges that may affect the accuracy of semantic map technique. While the uniform detail blended image 818 has defined edges.

FIG. 8D shows another use case scenario 822 of the high depth of field scene with one face in nearby regions (indoor scene). As shown, in “without touch focus” 824, the face and the nearby regions are in focus while far away regions are blurry. Further, in “touch focus at near point A” 826, near regions are in focus while far away regions are blurry. In “with touch focus at far point B” 828, near regions are less blurry while far away regions are in focus. Further, 830 represents the region 1, and 832 represents the region 2.

FIG. 8E shows a use case scenario 834 of enhancing the details of an image in which the object categories are fabrics, animals/pet fur, and furniture texture. Image 836a and image 836b are enhanced using the related art technique. Further, image 838 is enhanced using the system 200. In the image 838, the sharpening texture is higher than in the rest of the regions.

Similarly, in a use case scenario of enhancing the details of an image in which the object category is skin, faces, eyes, and hairs, the sharpening is done on skin, faces, eyes, and hair (different strength than texture). Further, in the use case scenario of enhancing the details of an image in which the object categories are leaves, grass, flowers, trees, and mountains, the sharpening is done on leaves (different strengths than texture & faces). Furthermore, in the use case scenario of enhancing the details of an image in which the object categories are buildings, structures, walls, high texture, and furniture surface, the sharpening is done on the texture.

FIG. 8F shows a use case scenario 840 for denoising an image 842. The image 842 includes noise at uniform regions and halos. Further, the system 200 reduces the noise in uniform regions and halos at the edges of the image 842 and obtains the image 844.

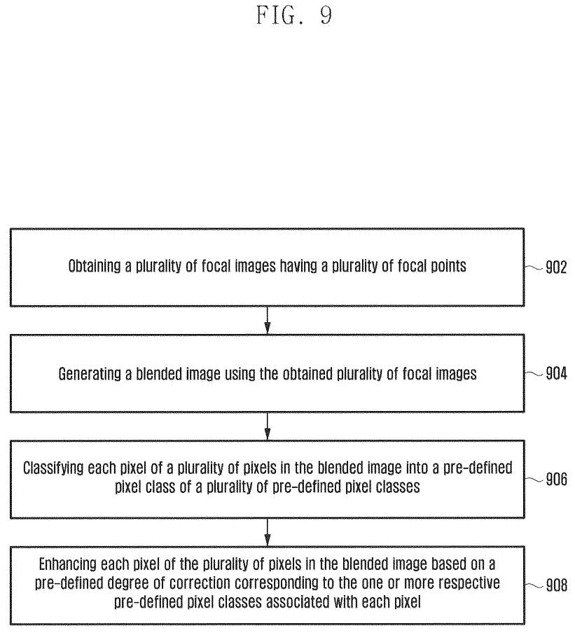

FIG. 9 is a flow diagram illustrating a method for enhancing details of the image, in accordance with an embodiment of the present disclosure. In an embodiment of the present disclosure, the method 900 is performed by the system 200, as explained with reference to FIGS. 2 and 3.

At step 902, the method 900 includes obtaining the plurality of focal images having the plurality of focal points.

At step 904, the method 900 includes generating the blended image using the obtained plurality of focal images.

At step 906, the method 900 includes classifying each pixel of the plurality of pixels in the blended image into the pre-defined pixel class of the plurality of pre-defined pixel classes.

At step 908, the method 900 includes enhancing each pixel of the plurality of pixels in the blended image based on the pre-defined degree of correction corresponding to the one or more respective pre-defined pixel classes associated with each pixel.

While the above steps shown in FIG. 9 are described in a particular sequence, the steps may occur in variations to the sequence in accordance with various embodiments of the present disclosure. Further, the details related to various steps of FIG. 9, which are already covered in the description related to FIGS. 2-8 are not discussed again in detail here for the sake of brevity.

The present disclosure provides for various technical advancements based on the features discussed above. Further, the present disclosure adaptively improves the details in the scene and performs denoising to provide a sharper image of a high quality. The present disclosure creates all focus images by combining multiple focus bracketed frames with a normal captured frame along with a depth map image. Accordingly, the present disclosure enhances the image by adaptive denoising and enhancing details using a lookup table based on the category of classes of pixels. Furthermore, the present disclosure ensures that there are no blurry regions in any of the captured scenes providing a true experience of high-resolution images. The present disclosure identifies the local regions having artifacts and enhances them instead of applying the enhancement to the full image. This local enhancement improves the processing time of the solution and makes it more efficient.

The plurality of modules 206 may be implemented by any suitable hardware and/or set of instructions. Further, the sequential flow associated with the plurality of modules 206 illustrated in FIG. 3 is exemplary in nature and the embodiments may include the addition/omission of steps as per the requirement. In some embodiments, the one or more operations performed by the plurality of modules 206 may be performed by the one or more processors 204 based on the requirement.

In an embodiment of the present disclosure, reasoning prediction is a technique of logical reasoning and predicting by determining information and includes, e.g., knowledge-based reasoning, optimization prediction, preference-based planning, or recommendation.

While specific language has been used to describe the present subject matter, any limitations arising on account thereto, are not intended. As would be apparent to a person having ordinary skill in the art, various working modifications may be made to the method in order to implement the features taught herein. The drawings and the foregoing description give examples of embodiments. Those skilled in the art will appreciate that one or more of the described elements may well be combined into a single functional element. Alternatively, certain elements may be split into multiple functional elements. Elements from an embodiment may be added to another embodiment.

What is claimed is:

1. A method of enhancing details of an image on an electronic device, the method comprising:
obtaining a plurality of focal images having a plurality of focal points;
generating a blended image using the obtained plurality of focal images;
classifying each pixel of a plurality of pixels in the blended image into a pre-defined pixel class of a plurality of pre-defined pixel classes;
enhancing each pixel of the plurality of pixels in the blended image based on a pre-defined degree of correction corresponding to respective pre-defined pixel classes associated with each pixel; and
providing the image including the enhanced plurality of pixels.

2. The method as claimed in claim 1, wherein the plurality of focal images are obtained from a secondary camera or a primary camera.

3. The method as claimed in claim 1, wherein the obtaining the plurality of focal images having the plurality of focal points comprises:
identifying a location of near and far object points associated with one or more objects appearing in a preview of a primary camera or a secondary camera by using a depth map and a stereo camera configuration; and
obtaining the plurality of focal images having the plurality of focal points based on the identified location of the near and far object points.

4. The method as claimed in claim 3, wherein the depth map is obtained from at least one of a preview of the primary camera or the secondary camera by using an artificial intelligent (AI) model, or a depth camera.

5. The method as claimed in claim 1, wherein the plurality of focal images comprise a near-focused image, a far-focused image, and a de-focused image.

6. The method as claimed in claim 1, wherein the generating the blended image comprises:
identifying one or more common regions in each of the plurality of focal images using at least one of a warping process or a registering process; and
generating the blended image by fusing each of the plurality of focal images based on the one or more common regions.

7. The method as claimed in claim 1, wherein the generating the blended image comprises generating the blended image by warping one or more images from the plurality of focal images.

8. The method as claimed in claim 1, wherein the classifying each pixel of the plurality of pixels in the blended image comprises:
generating an edge map of the blended image;
classifying each pixel of the plurality of pixels of the blended image into the pre-defined pixel class based on the edge map and a depth map; and
obtaining a semantic map corresponding to the pre-defined pixel class from the edge map.

9. The method as claimed in claim 8, wherein the enhancing the details further comprises:
obtaining a denoised image from the blended image;
obtaining a global sharpened image based on the denoised image and a de-focused image from the plurality of focal images;
obtaining a low-frequency component, a mid-frequency component, and a high-frequency component of the blended image from the denoised image;
generating an adaptively denoised and detail-enhanced (ADE) image corresponding to each of the plurality of pre-defined pixel classes and the obtained semantic map, wherein the ADE image is generated based on the denoised image, the global sharpened image, a pre-defined degree of correction corresponding to each of the plurality of pre-defined pixel classes, a defocused image from the plurality of focal images, and the obtained low-frequency component, mid-frequency component, and high-frequency component of the blended image; and
generating a final ADE image by blending the generated ADE image based on the plurality of pre-defined pixel classes.

10. A system for enhancing details of an image on an electronic device, the system comprising:
a memory storing instructions;
one or more processors communicably coupled to the memory,
wherein the instructions, when executed by the one or more processors, cause the electronic device to:
obtain a plurality of focal images having a plurality of focal points;
generate a blended image using the obtained plurality of focal images;
classify each pixel of a plurality of pixels in the blended image into a pre-defined pixel class of a plurality of pre-defined pixel classes;
enhance each pixel of the plurality of pixels in the blended image based on a pre-defined degree of correction corresponding to the respective pre-defined pixel classes associated with each pixel; and
provide the image including the enhanced plurality of pixels.

11. The system as claimed in claim 10, wherein the plurality of focal images are obtained from a secondary camera or a primary camera.

12. The system as claimed in claim 10, wherein, in obtaining the plurality of focal images having the plurality of focal points, the one or more processors are configured to:
identify a location of near and far object points associated with one or more objects appearing in a preview of at least a primary camera or a secondary camera by using a depth map and a stereo camera configuration; and
obtain the plurality of focal images having the plurality of focal points based on the identified location of the near and far object points.

13. The system as claimed in claim 12, wherein the depth map is obtained from at least one of a preview of the primary camera or the secondary camera by using an artificial intelligence (AI) model or a depth camera.

14. The system as claimed in claim 10, wherein the plurality of focal images comprise a near-focused image, a far-focused image, and a de-focused image.

15. The system as claimed in claim 10, wherein, in generating the blended image, the one or more processors are configured to:
identify one or more common regions in each of the plurality of focal images using at least one of a warping process or a registering process; and
generate the blended image by fusing each of the plurality of focal images based on the one or more common regions.
